(19) United States
(12) Patent Application Publication
(10) Pub. No.: US 2014/0198862 A1
(43) Pub. Date: Jul. 17, 2014

(54) COMMUNICATION DEVICE AND COMMUNICATION SYSTEM

(71) Applicant: MegaChips Corporation, Osaka-shi (JP)

(72) Inventor: Handa Chen, Osaka-shi (JP)

(73) Assignee: MegaChips Corporation, Osaka-shi (JP)

(21) Appl. No.: 14/236,250

(22) PCT Filed: Sep. 25, 2012
(86) PCT No.: PCT/JP12/74530

§ 371 Date: Jan. 30, 2014

(30) Foreign Application Priority Data
Oct. 20, 2011 (JP) 2011-230435

(51) Int. Cl. H04L 25/03

(52) U.S. Cl. CPC H04L 25/03
USPC 375/259

(57) ABSTRACT

A transmitter includes a generation section that generates a baseband OFDM signal based on transmission data, and a transmission section that transmits a communication signal that is based on a real-part signal that is obtained by removing an imaginary-part signal from the baseband OFDM signal. In the baseband OFDM signal, the data signal including the transmission data is superimposed on subcarriers that are given numbers equal to or less than N/2−1, and the data signal is not superimposed on subcarriers that are given numbers more than N/2−1, where N (N is an integer) subcarriers included in the baseband OFDM signal are numbered by integers from 0 to N−1 in ascending order with respect to the center frequency of each subcarrier.

### TECHNICAL FIELD

The present invention relates to a communication technology.

### BACKGROUND ART

There is a technique of performing communication by using an OFDM (Orthogonal Frequency Division Multiplexing) signal constituted of a plurality of subcarriers orthogonal to each other (for example, Patent Document 1).

An ordinary communication device (transmitter) for transmitting the OFDM signal is configured to perform a primary modulation for mapping transmission data on a complex plane to thereby obtain a complex symbol, and then perform an inverse fast Fourier transform (IFFT) on the complex symbol, to generate a baseband OFDM signal. Then, the communication device performs a predetermined process, such as a quadrature modulation and a frequency conversion, on the baseband OFDM signal, to generate a carrier-band OFDM signal. The communication device outputs the carrier-band OFDM signal as a communication signal to a channel.

On the other hand, an ordinary communication device (receiver) for receiving the OFDM signal is configured to perform a predetermined process, such as a frequency conversion and a quadrature detection, on the reception signal, to generate a baseband OFDM signal. Then, the communication device performs a demodulation process, such as a fast Fourier transform (FFT) and a demapping process, on the baseband OFDM signal, to modulate data.

### PRIOR-ART DOCUMENTS

### Patent Documents

Patent Document 1: Japanese Patent Application Laid-Open No. 2001-230751

### SUMMARY OF THE INVENTION

### Problems to be Solved by the Invention

In each of these communication devices, it is preferable that downsizing of the communication device is achieved without impairing a communication function for communicating information.

Therefore, an object of the present invention is to provide a technique that enables downsizing of a communication device to be achieved.

### Means for Solving the Problems

A first aspect of a communication device according to the present invention includes: a generation means configured to generate a baseband OFDM signal based on transmission data; and a transmission means configured to transmit a communication signal that is based on a real-part signal that is obtained by removing an imaginary-part signal from the baseband OFDM signal. In the baseband OFDM signal, a data signal including the transmission data is superimposed on a subcarrier that is given a number equal to or less than N/2−1, and the data signal is not superimposed on a subcarrier that is given a number more than N/2−1, where N (N is an integer) subcarriers included in the baseband OFDM signal is numbered by integers from 0 to N−1 in ascending order with respect to the center frequency of each subcarrier.

A second aspect of the communication device according to the present invention is the first aspect, in which the generation means includes: an assignment means configured to assign the data signal having a primary modulation performed thereon to the subcarrier given the number equal to or less than N/2−1 and assign zero to the subcarrier given the number more than N/2−1, to generate parallel data; and an inverse Fourier transform means configured to convert the parallel data from data in frequency domain into data in time domain, and output the baseband OFDM signal.

A third aspect of the communication device according to the present invention includes: a reception means configured to receive a communication signal; and a modulation means configured to modulate the communication signal and thereby obtain reception data. The communication signal is a signal based on a real-part signal that is obtained by removing an imaginary-part signal from a baseband OFDM signal. The modulation means includes a Fourier transform means configured to convert the communication signal from a signal in time domain into a signal in frequency domain. The Fourier transform means is configured to receive a signal that is based on the communication signal as a real-number signal and receive zero as an imaginary-number signal.

A first aspect of a communication system according to the present invention includes: a first communication device; and a second communication device configured to communicate with the first communication device. The first communication device includes: a generation means configured to generate a baseband OFDM signal based on transmission data; and a transmission means configured to transmit a communication signal that is based on a real-part signal that is obtained by removing an imaginary-part signal from the baseband OFDM signal. The first communication device is configured such that, in the baseband OFDM signal, a data signal including the transmission data is superimposed on a subcarrier that is given a number equal to or less than N/2−1, and the data signal is not superimposed on a subcarrier that is given a number more than N/2−1, where N (N is an integer) subcarriers included in the baseband OFDM signal is numbered by integers from 0 to N−1 in ascending order with respect to the center frequency of each subcarrier. The second communication device includes: a reception means configured to receive the communication signal; and a modulation means configured to modulate the communication signal and thereby obtain reception data. The modulation means includes a Fourier transform means configured to convert the communication signal from a signal in time domain into a signal in frequency domain. The Fourier transform means is configured to receive a signal that is based on the communication signal as a real-number signal and receive zero as an imaginary-number signal.

A second aspect of the communication system according to the present invention is the first aspect, in which the generation means includes: an assignment means configured to assign the data signal having a primary modulation performed thereon to the subcarrier given the number equal to or less than N/2−1 and assign zero to the subcarrier given the number more than N/2−1, to generate parallel data; and an inverse Fourier transform means configured to convert the parallel data from data in frequency domain into data in time domain, and output the baseband OFDM signal.

A fourth aspect of the communication device according to the present invention includes: a generation means configured to generate a baseband OFDM signal based on transmission data; and a transmission means configured to transmit a communication signal that is based on a real-part signal that is obtained by removing an imaginary-part signal from the baseband OFDM signal. In the baseband OFDM signal, a data signal including the transmission data is superimposed on a subcarrier that is given a number more than N/2−1, and the data signal is not superimposed on a subcarrier that is given a number equal to or less than N/2−1, where N (N is an integer) subcarriers included in the baseband OFDM signal is numbered by integers from 0 to N−1 in ascending order with respect to the center frequency of each subcarrier.

A third aspect of the communication system according to the present invention includes: a first communication device; and a second communication device configured to communicate with the first communication device. The first communication device includes: a generation means configured to generate a baseband OFDM signal based on transmission data; and a transmission means configured to transmit a communication signal that is based on a real-part signal that is obtained by removing an imaginary-part signal from the baseband OFDM signal. The first communication device being configured such that, in the baseband OFDM signal, a data signal including the transmission data is superimposed on a subcarrier that is given a number more than N/2−1, and the data signal is not superimposed on a subcarrier that is given a number equal to or less than N/2−1, where N (N is an integer) subcarriers included in the baseband OFDM signal is numbered by integers from 0 to N−1 in ascending order with respect to the center frequency of each subcarrier. The second communication device includes: a reception means configured to receive the communication signal; and a modulation means configured to modulate the communication signal and thereby obtain reception data. The modulation means includes a Fourier transform means configured to convert the communication signal from a signal in time domain into a signal in frequency domain. The Fourier transform means is configured to receive a signal that is based on the communication signal as a real-number signal and receive zero as an imaginary-number signal.

### Effects of the Invention

The present invention enables downsizing of a communication device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 A configuration diagram of a communication system according to an embodiment.

FIG. 2 A diagram showing a configuration of a transmitter according to this embodiment.

FIG. 3 A diagram showing a configuration of a receiver according to this embodiment.

FIG. 4 A diagram showing an OFDM signal including subcarriers having subcarrier Nos. “0” to “N−1”.

FIG. 5 A conceptual diagram showing that an input signal inputted to an IFFT unit is an even function.

FIG. 6 A conceptual diagram showing that an input signal inputted to the IFFT unit is an odd function.

FIG. 7 A diagram showing data that has been used for computer simulation.

FIG. 8 A diagram showing data that has been used for computer simulation.

FIG. 9 A diagram showing a result of the computer simulation.

FIG. 10 A diagram showing a result of the computer simulation.

FIG. 11 A diagram showing a result of the computer simulation.

### EMBODIMENT FOR CARRYING OUT THE INVENTION

In the following, an embodiment will be described with reference to the drawings.

### Embodiment

### 1. Configuration of Communication System

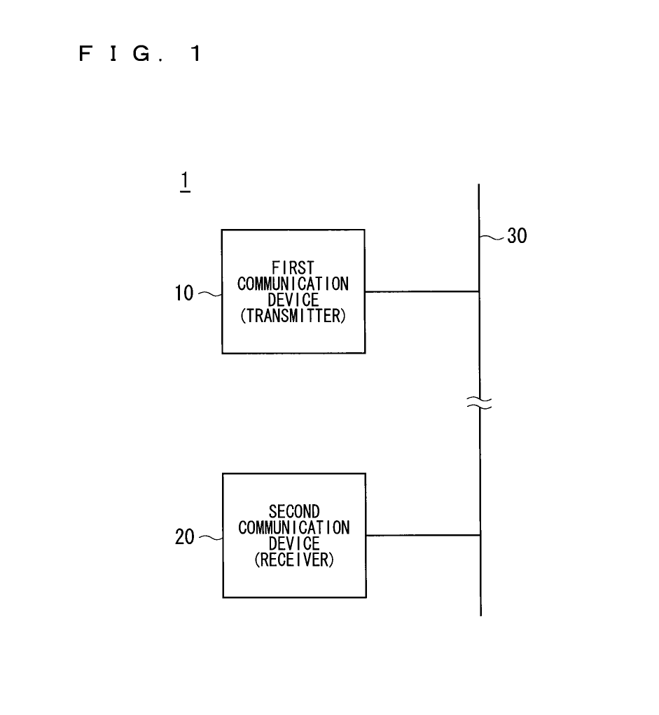

FIG. 1 is a configuration diagram of a communication system 1 according to this embodiment.

As shown in FIG. 1, the communication system 1 includes a first communication device 10 and a second communication device 20. The first communication device 10 and the second communication device 20 included in the communication system 1 are communicable with each other via wired communication. A channel 30 that electrically connects the first communication device 10 to the second communication device 20 may be an ordinary communication line, or alternatively may be a power line. In a case where the channel is a power line, the first communication device 10 and the second communication device 20 perform communication via power line communication (PLC: power line communication).

The wired communication between the communication devices 10 and 20 is performed with use of an OFDM (Orthogonal Frequency Division Multiplexing) signal obtained as a result of synthesis of a plurality of subcarriers that are orthogonal to each other on a frequency axis. The OFDM signal is separated by a certain time unit, and transmitted on a packet basis.

In the communication system 1, data transmission is performed by using, among all subcarriers included in the OFDM signal, subcarriers included in a predetermined band. Details of the subcarriers used for data transmission will be described later.

In a case illustrated below, the first communication device 10 functions as a transmitter and the second communication device 20 functions as a receiver. However, this is not limiting. That is, the first communication device 10 has at least a transmission function, and may have a reception function in addition to the transmission function. Likewise, the second communication device 20 has at least a reception function, and may have a transmission function in addition to the reception function.

### 2. Configuration of Transmitter

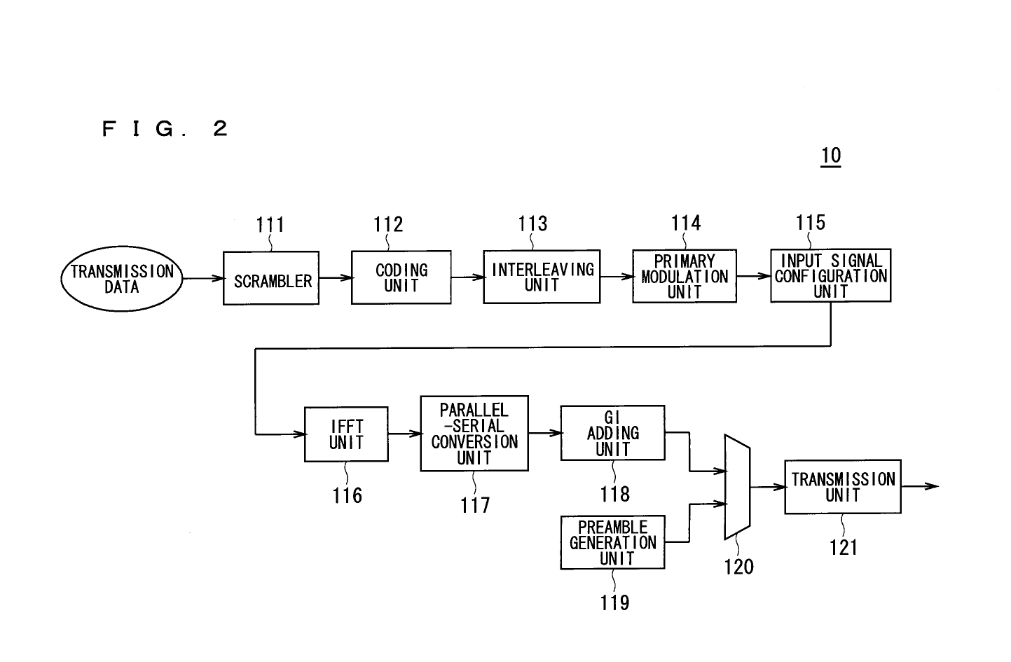

Next, a configuration of the transmitter 10 included in the communication system 1 will be described. FIG. 2 is a diagram showing a configuration of the transmitter 10 according to this embodiment.

As shown in FIG. 2, the transmitter 10 includes a scrambler 111, a coding unit 112, an interleaving unit (interleaver) 113, a primary modulation unit 114, an input signal configuration unit 115, an IFFT (inverse fast Fourier transform) unit 116, a parallel/serial conversion unit (parallel-serial conversion unit) 117, a GI adding unit 118, a preamble generation unit 119, a packet configuration unit 120, and a transmission unit 121.

To be specific, the scrambler 111 performs a scrambling process on transmission data inputted thereto, for scrambling the data and rearranging the order thereof. The transmission data on which the scrambling process has been performed by the scrambler 111 is inputted to the coding unit 112.

The coding unit 112 performs redundancy coding for error correction on the transmission data on which the scrambling process has been performed. For example, a convolutional code whose original code has a constraint length of k=7 and a code rate of ½ is used for the redundancy coding. A bit sequence of the transmission data outputted from the coding unit 112 is inputted to the interleaving unit 113.

The interleaving unit 113 performs bit interleave for rearranging the bit sequence of the transmission data, in order to prevent an unequal concentration of an error in one symbol. The transmission data outputted from the interleaving unit 113 is inputted to the primary modulation unit 114.

The primary modulation unit 114 maps (associates) the transmission data in a subcarrier on a symbol basis in accordance with a predetermined modulation scheme (for example, QPSK, 16QAM).

Herein, the symbol (Symbol) represents a configuration unit of a segment of transmission data that is superimposed on the carrier wave (subcarrier), which is defined for each modulation scheme. To avoid confusion with an OFDM symbol which will be described later, the symbol herein will be also referred to as a data symbol or a complex symbol. For example, in QPSK, transmission data that can be transmitted in one symbol (one data symbol) is two bits.

The input signal configuration unit 115 has a function for converting the data symbol inputted from the primary modulation unit 114 into a predetermined number of parallel data units, in order that a data signal made of a buffer and the like and including the transmission data be dispersedly superimposed on a subcarrier.

More specifically, in the communication system 1, data transmission is performed by using, among all subcarriers included in the OFDM signal, subcarriers included in a predetermined band, as described above. Therefore, the input signal configuration unit 115 assigns the data signal to the subcarriers included in the predetermined band, and assigns 0 (zero) to the other subcarriers different from the subcarriers included in the predetermined band, to thereby generate parallel data units, and outputs the parallel data units to the IFFT unit 116.

In this manner, the input signal configuration unit 115 functions as an assignment means for assigning a data signal to each subcarrier. Details of the predetermined band including the subcarriers that are used for data transmission will be described later.

The IFFT unit 116 performs an inverse fast Fourier transform on the parallel data units inputted from the input signal configuration unit 115, to convert data in the frequency domain to data in the time domain. The data in the frequency domain, which is inputted from the input signal configuration unit 115, is data of the amplitude and phase of each subcarrier. The IFFT unit 116 generates time data corresponding to one OFDM symbol from amplitude phase data of each subcarrier.

The time data generated by the IFFT unit 116 is complex data in the time domain. The IFFT unit 116 generates time data of I-axis component (in-phase component, real component) and time data of Q-axis component (quadrature component, imaginary component).

In this embodiment, among the complex data in the time domain generated by the IFFT unit 116, the time data of the I-axis component is inputted to the parallel-serial conversion unit 117 while the time data of the Q-axis component is discarded.

The parallel-serial conversion unit 117 has a function for converting parallel data inputted from the IFFT unit 116 into serial data. The serial data outputted from the parallel-serial conversion unit 117 is, as an OFDM signal in the baseband (baseband OFDM signal), inputted to the GI adding unit 118.

The GI adding unit 118 performs a process for adding a guard interval (GI) to the baseband OFDM signal inputted from the parallel-serial conversion unit 117, and outputs the baseband OFDM signal having the GI added thereto to the packet configuration unit 120.

The preamble generation unit 119 has a function for generating and outputting a preamble signal for use in various types of synchronous processing performed at the receiver side, such as frame synchronization and frequency synchronization.

The packet configuration unit 120 adds the preamble signal to the OFDM signal outputted from the GI adding unit 118, to generate a signal of a packet unit (also referred to as “packet signal”).

The transmission unit 121 performs a DA conversion process for converting the packet signal in digital form generated by the packet configuration unit 120 into a packet signal in analog form, and outputs, as a communication signal, the packet signal obtained as a result of the DA conversion process. The communication signal outputted from the transmission unit 121 is transmitted to the receiver 20 via the channel 30.

Thus, in the transmitter 10, among the complex data in the time domain generated by the IFFT unit 116, the time data of the imaginary component is discarded, and the OFDM signal (also referred to as “real-part OFDM signal”) generated based on the time data of the real component is transmitted as the communication signal. This enables the transmitter 10 to transmit a real-number signal without performing any quadrature modulation. Therefore, a configuration for performing a quadrature modulation need not be provided in the transmitter 10.

In a conventional transmitter, a quadrature modulation is performed on a baseband OFDM signal on which the IFFT process has been performed, and, among the signal obtained as a result of the quadrature modulation, a signal of a real number part is transmitted as a carrier-band OFDM signal. In the transmitter 10 of this embodiment, on the other hand, no quadrature modulation is performed on the baseband OFDM signal on which the IFFT process has been performed, and a signal of a real number part (real-part signal) is extracted from the baseband OFDM signal, and this signal of the real number part is transmitted.

The transmitter 10 configured as described above can be also expressed as including a generation means for generating a baseband OFDM signal based on transmission data, and a communication means for transmitting a communication signal that is based on a real-part signal obtained by removing an imaginary-part signal from the generated baseband OFDM signal. That is, the generation means for generating the baseband OFDM signal includes the scrambler 111, the coding unit 112, the interleaving unit 113, the primary modulation unit 114, the input signal configuration unit 115, the IFFT unit 116, and the parallel-serial conversion unit 117; and the transmission means includes the GI adding unit 118 and the transmission unit 121.

### 3. Configuration of Receiver

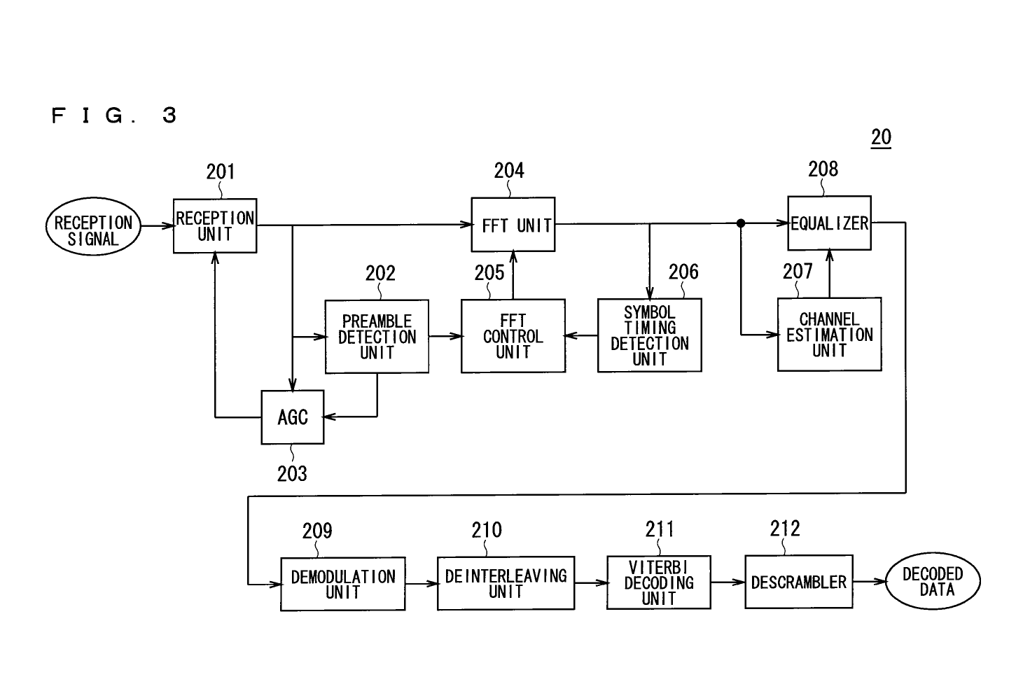

Next, the receiver 20 included in the communication system 1 will be described. FIG. 3 is a diagram showing a configuration of the receiver 20 according to this embodiment.

As shown in FIG. 3, the receiver 20 includes a reception unit 201, a preamble detection unit 202, an AGC (automatic gain control) unit 203, a FFT (fast Fourier transform) unit 204, a FFT control unit 205, a symbol timing detection unit 206, a channel estimation unit 207, an equalizer 208, a demodulation unit 209, a deinterleaving unit 210, a Viterbi decoding unit 211, and a descrambler 212.

The communication signal transmitted from the transmitter 10 is sent to the receiver 20 via the channel 30. The receiver 20 receives the communication signal in the reception unit 201.

The reception unit 201 performs a filtering process, an AD conversion process, and the like, on the received communication signal (reception signal). Then, the reception unit 201 outputs the reception signal in digital form to the preamble detection unit 202, the AGC (automatic gain control) unit 203, and the FFT unit 204.

The communication signal used in this communication system 1 is a signal on which no quadrature modulation has been performed on the transmitter side. Therefore, a quadrature detection is not necessary in the receiver side. Accordingly, the receiver 20 of this embodiment does not include a configuration for the quadrature detection, and a low pass filter for removing a signal of a high frequency component generated as a result of the quadrature detection.

The preamble detection unit 202 performs a preamble signal detection process for detecting a preamble signal included in the reception signal. The preamble signal detection process can be performed by using, for example, correlation calculation. Upon detection of a preamble signal, the preamble detection unit 202 outputs a signal (detection signal) indicating detection of the preamble signal to the AGC unit 203 and the FFT control unit 205.

In accordance with the input of the preamble detection signal from the preamble detection unit 202, the AGC unit 203 performs gain adjustment so as to cause signals at different reception levels to be signals at a proper level.

The FFT control unit 205 outputs a control signal to the FFT unit 204 based on a symbol timing, to control a timing of execution of an FFT process that is performed by the FFT unit 204.

Upon input of the preamble detection signal from the preamble detection unit 202, the FFT control unit 205 identifies the symbol timing based on a timing of detection of the preamble signal. Since the configuration of a packet signal is known, the FFT control unit 205 is able to identify the symbol timing based on the timing of detection of the preamble signal. The symbol timing identified based on the timing of detection of the preamble signal in the FFT control unit 205 is a provisional symbol timing, and a fine adjustment is made on the symbol timing later.

The symbol timing detection unit 206 detects a formal symbol timing by using an LTF 51L included in a preamble 51 of a packet. The formal symbol timing detected by the symbol timing detection unit 206 is notified to the FFT control unit 205. Upon notification of the formal symbol timing, the FFT control unit 205 controls the timing of execution of the FFT process based on the formal symbol timing.

The FFT unit 204 performs a so-called multicarrier demodulation process for performing a fast Fourier transform on the reception signal to convert a signal in the time domain into a signal in the frequency domain. The reception signal obtained as a result of the multicarrier demodulation process, which is outputted from the FFT unit 204, is inputted to the channel estimation unit 207 and the equalizer 208.

The FFT unit 204 receives a real-number signal and an imaginary-number signal. Here, in the receiver 20, a signal based on the reception signal on which a sequence of reception processes have been performed by the reception unit 201 is inputted as the real-number signal to the FFT unit 204. As the imaginary-number signal, for example, zero is inputted.

The channel estimation unit (channel estimation means) 207 estimates characteristics of the channel by comparing the preamble signal included in the reception signal against a known preamble signal that is stored in advance in a storage unit of the receiver 20. The channel characteristics (also referred to as “estimated channel characteristics”) estimated by the channel estimation unit 207 is outputted to the equalizer 208.

The equalizer (equalization processing means) 208 performs an equalization process for dividing the reception signal by the estimated channel characteristics corresponding to this reception signal and thereby removing a channel distortion. The reception signal obtained as a result of the equalization process, which is outputted from the equalizer 208, is outputted to the demodulation unit 209.

The demodulation unit 209 performs a subcarrier demodulation process such as a demapping process on the reception signal obtained as a result of the equalization process, and outputs the reception signal thus modulated to the deinterleaving unit 210.

The deinterleaving unit 210 performs deinterleaving for restoring the reception signal that has been rearranged in the transmitter side. The reception signal thus deinterleaved is outputted to the Viterbi decoding unit 211. The Viterbi decoding unit 211 performs error correction decoding on the reception signal.

The descrambler 212 performs a descrambling process on the reception signal outputted from the Viterbi decoding unit 211. As a result, decoded data corresponding to the transmission data is generated.

In the receiver 20, as thus far described, no quadrature detection is performed, and the multicarrier demodulation process is performed on the reception signal in the FFT unit 204.

In the receiver 20 of this embodiment, a demodulation means that obtains the decoded data (reception data) includes the preamble detection unit 202, the FFT unit 204, the FFT control unit 205, the symbol timing detection unit 206, the channel estimation unit 207, the equalizer 208, the demodulation unit 209, the deinterleaving unit 210, the Viterbi decoding unit 211, and the descrambler 212.

### 4. Aspect of Use of Subcarriers of OFDM Signal

Next, a detailed description will be given to an aspect of use of subcarriers in the OFDM signal used in the above-described communication system 1. FIG. 4 is a diagram showing an OFDM signal LS including subcarriers having subcarrier Nos. “0” to “N−1”.

In the communication system 1, as described above, data transmission is performed by using, among all subcarriers included in the OFDM signal, subcarriers included in a predetermined band.

To be specific, the subcarriers used for data transmission are subcarriers that are given the numbers equal to or less than N/2−1, where N subcarriers included in the OFDM signal are numbered by integers from 0 to N−1 in ascending order with respect to the frequency (center frequency) of each subcarrier.

Among the subcarriers, the subcarriers used for data transmission will be also referred to as “use subcarrier” or “transmission subcarrier”. For example, in the OFDM signal LS shown in FIG. 4, subcarriers included in a zone LK are the use subcarriers. That is, in the communication system 1, data transmission is performed with a data signal including transmission data being superimposed on, among the plurality of subcarriers included in the OFDM signal LS, the subcarriers included in a predetermined band in the zone LK. The predetermined band is a transmission band used for data transmission, and this transmission band includes the use subcarriers.

On the other hand, the subcarriers that are given numbers more than N/2−1 are subcarriers not used for data transmission (which will be also referred to as “non-use subcarrier” or “non-transmission subcarrier”). In the communication, zero is superimposed on the non-use subcarriers.

Thus, in the communication system 1, data transmission is performed by using the subcarriers that are given numbers equal to or less than N/2−1 and included in the transmission band, where N subcarriers included in the OFDM signal are numbered by integers from 0 to N−1 in ascending order with respect to the frequency of each subcarrier. This enables the transmission data to be restored in the receiver side even in a case where a signal of a real number part of the baseband OFDM signal obtained as a result of the IFFT process is used as the communication signal. In a precise sense, N is a power of two, which is an even number.

### 5. Principle of Restoration of Transmission Data

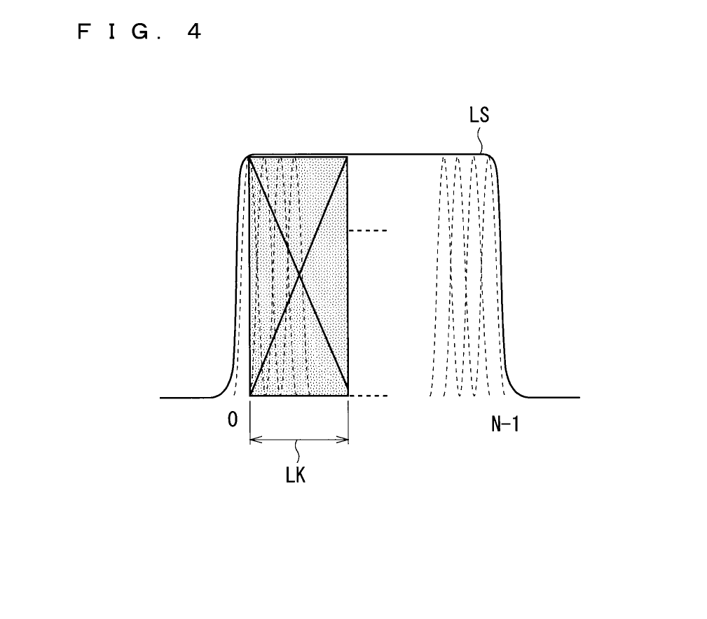

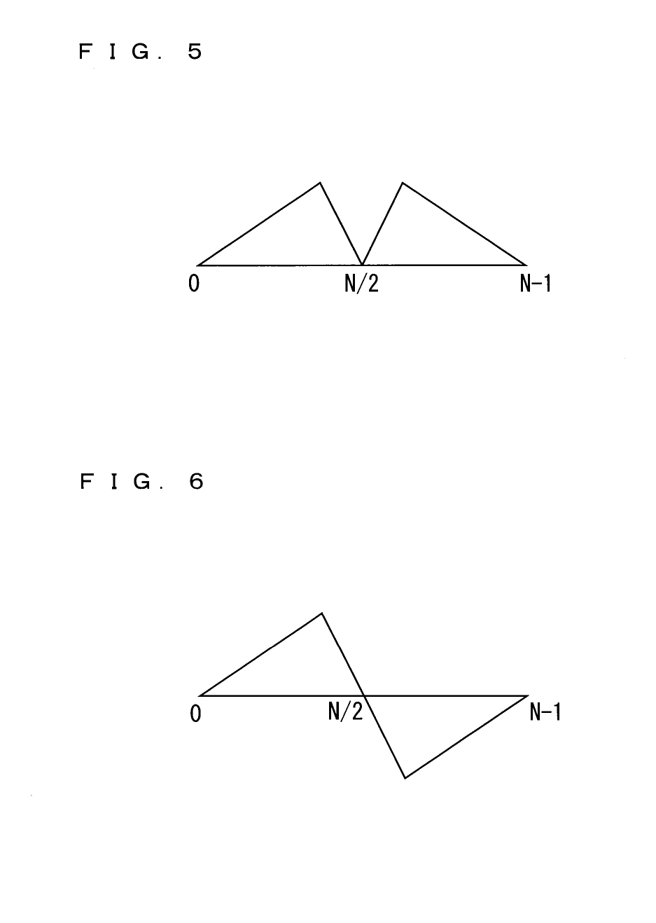

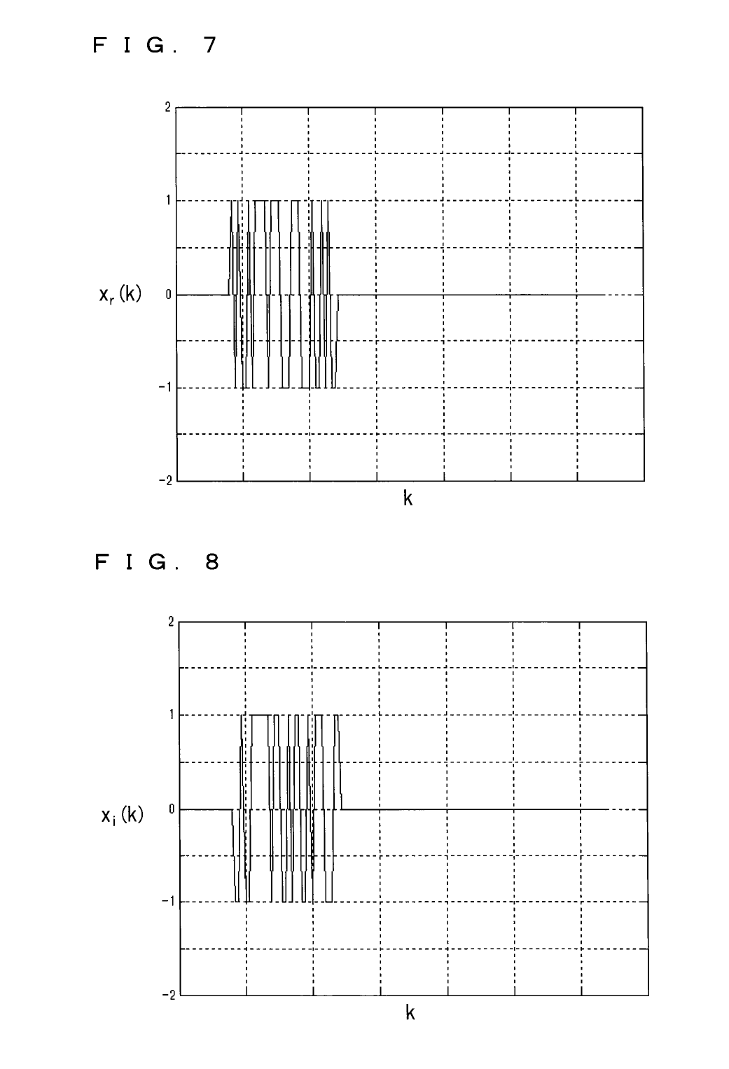

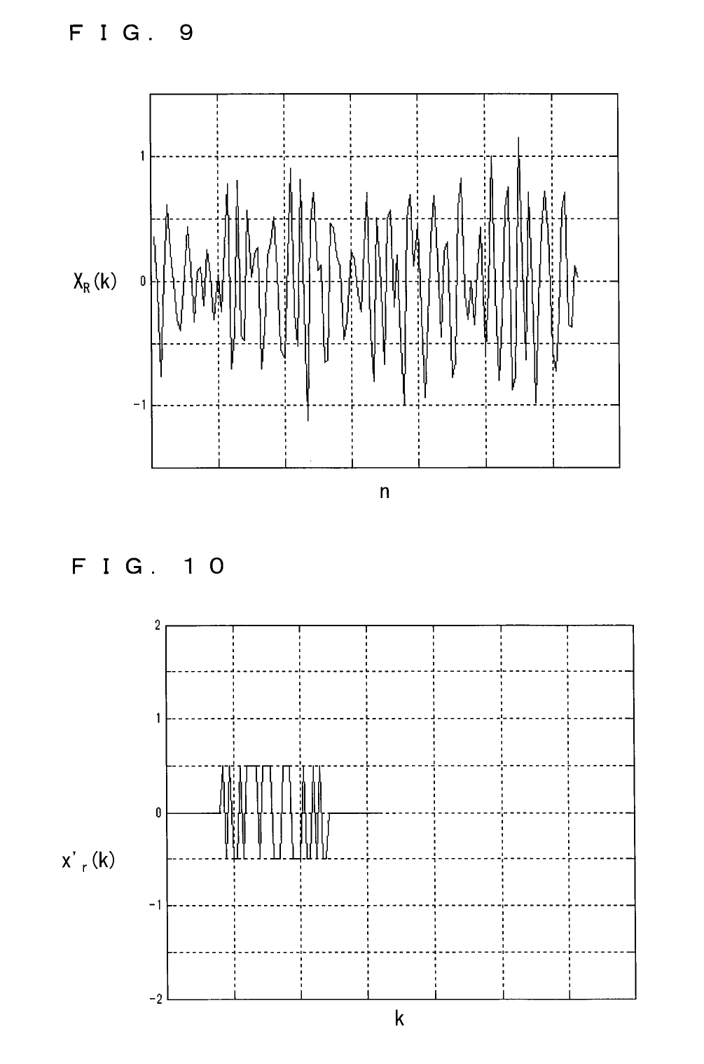

Next, the principle of restoration of transmission data will be described. FIG. 5 is a conceptual diagram showing that an input signal inputted to the IFFT unit is an even function. FIG. 6 is a conceptual diagram showing that an input signal inputted to the IFFT unit is an odd function. FIGS. 7 and 8 are diagrams showing data that has been used for computer simulation. FIGS. 9 to 11 are diagrams showing a result of the computer simulation.

The theory of Fourier transform includes a theorem that “when an input to an FFT unit is an even function of a real number, an output from the FFT unit is an even function of a real number, and when the input is an odd function of a real number, an output from the FFT unit is an odd function of an imaginary number”. Since FFT computation and IFFT computation are contrapositive to each other, this theorem applies not only to the FFT computation but also to the IFFT computation.

The following expressions (1) and (2) are mathematical expressions of the theorem concerning the IFFT computation.

$$\begin{matrix}[ Math . 1 ] & \\ {h}_{e} ( k ) {⇒}^{IFFT} {R}_{e} ( n ) = {\sum }_{k = 0}^{N / 2 - 1} 2 {h}_{e} ( k ) cos ( \frac{2 π nk}{N} ) & ( 1 ) \\ [ Math . 2 ] & \\ {h}_{o} ( k ) {⇒}^{IFFT} {jI}_{o} ( n ) = j {\sum }_{k = 0}^{N / 2 - 1} 2 {h}_{o} ( k ) sin ( \frac{2 π nk}{N} ) & ( 2 )\end{matrix}$$

In the expression (1), hₑ(k) represents an even function of a real number before the IFFT process, and hₒ(k) represents an odd function of a real number before the IFFT process. The expression (1) indicates a transform from an hₑ(k) signal at the point N into an Rₑ(n) signal at the point N. The expression (2) indicates a transform from an hₒ(k) signal at the point N into an Iₑ(n) signal at the point N.

Here, under the condition that a complex signal x(k) is inputted to the IFFT unit, a real part of the complex signal is an even function, and an imaginary part of the complex signal is an odd function; the following expression (3) is established based on the expressions (1) and (2).

$$\begin{matrix}[ Math . 3 ] & \\ x ( k ) = {x}_{e} ( k ) + {jx}_{o} ( k ) {⇒}^{IFFT} X ( n ) = {\sum }_{k = 0}^{N / 2 - 1} 2 [ {x}_{e} ( k ) cos ( \frac{2 π nk}{N} ) - {x}_{o} ( k ) sin ( \frac{2 π nk}{N} ) ] & ( 3 )\end{matrix}$$

The expression (3) indicates that, when a real part of a complex signal inputted to the IFFT unit is an even function and an imaginary part thereof is an odd function, an output of the IFFT unit is a real-number signal. In a case where an output signal outputted from the IFFT unit is a real-number signal, it is not necessary to perform quadrature modulation on the output signal outputted from the IFFT unit. Thus, the output signal outputted from the IFFT unit can be used, without any change added thereto, as the communication signal which will be transmitted to the outside.

Since the IFFT computation is computation performed on a signal at the point N, the definitions of the even function and the odd function are slightly different from the mathematical definitions. More specifically, in the IFFT computation, the even function means that N data units are symmetrical with respect to the line passing through the center point (lateral-symmetrical with respect to the center point), as shown in FIG. 5. In the mathematical expression, it is expressed as h(n)=h(N−n). In the IFFT computation, the odd function means that N data units are point-symmetrical with respect to the center point, as shown in FIG. 6. In the mathematical expression, it is expressed as h(n)=−h(N−n).

As described above, in order that the output of the IFFT unit be a real-number signal, it is necessary that a real part of the complex signal inputted to the IFFT unit is an even function while an imaginary part thereof is an odd function. A situation where a real part and an imaginary part of the input signal inputted to the IFFT unit is an even function and an odd function, respectively, corresponds to a situation where each of a real part and an imaginary part of the input signal has a symmetric property.

In this manner, when a data signal having the symmetric property is inputted to the IFFT unit, an output of a real-number signal from the IFFT unit can be obtained theoretically.

In a transmitter, however, a signal obtained as a result of the IFFT process is subjected to a band-pass filter, in order to limit expansion of a band used for communication. When a data signal having the symmetric property is inputted to the IFFT unit and a signal obtained as a result of the IFFT process is subjected to the band-pass filter, a distortion occurs in a communication signal because of an influence of non-ideal characteristics of the band-pass filter, which may impair the symmetric property of the data signal. In a case where the symmetric property of the data signal is impaired, the receiver 20 receives the data signal having no symmetric property and therefore the transmission data cannot be restored.

Accordingly, in the transmitter 10 of this embodiment, the data signal is superimposed on the subcarriers that are given numbers equal to or less than “N/2−1”, where the N subcarriers included in the OFDM signal are numbered by integers from 0 to N−1 in ascending order with respect to the frequency of each subcarrier. The transmitter 10 performs communication without superimposing the data signal on the subcarriers that are given the numbers more than N/2−1.

Not superimposing the data signal on, among all the subcarriers, the subcarriers not included in the transmission band can limit a band of the communication signal outputted from the transmitter 10. Thus, the need for the band-pass filter is eliminated.

Since the need for the band-pass filter is eliminated, data transmission can be performed without causing any distortion in the communication signal.

In a case where the subcarriers not included in the transmission band among all the subcarriers serve as non-use subcarriers, it is impossible that a data signal having the symmetric property is inputted to the IFFT unit 116. Therefore, an output of the IFFT unit 116 is a complex signal including a real part and an imaginary part.

Here, assuming that a real part of the complex signal outputted from the IFFT unit 116 as a result of an input of a data signal to the IFFT unit 116 under the condition that the subcarriers not included in the transmission band among all the subcarriers serve as non-use subcarriers has the same shape as the shape of a real-number signal outputted from an IFFT unit as a result of an input of a data signal having the symmetric property to the IFFT unit; transmitting the real part of the complex signal outputted from the IFFT unit 116 enables the receiver side to restore the transmission data.

In the following, an examination will be made about whether or not the receiver side is able to restore the transmission data in a case where the transmission data is transmitted under the condition that the subcarriers not included in the transmission band among all the subcarriers serve as non-use subcarriers.

Firstly, the input signal x(k) inputted to the IFFT unit 116 is defined as the following expression (4).

$$\begin{matrix}[ Math . 4 ] & \\ x ( k ) = \{ \begin{matrix}{x}_{r} ( k ) + {jx}_{i} ( k ) & 0 \leq k \leq \frac{N}{2} - 1 \\ 0 & \frac{N}{2} \leq k \leq N - 1\end{matrix} & ( 4 )\end{matrix}$$

In the expression (4), N represents the number of subcarriers included in the OFDM signal.

Performing the IFFT process on the signal x(k) indicated by the expression (4) results in a signal X(n) obtained as a result of the IFFT process as indicated by the expression (5).

$$\begin{matrix}[ Math . 5 ] & \\ X ( n ) = {\sum }_{k = 0}^{N - 1} [ {x}_{r} ( k ) + {jx}_{i} ( k ) ] {e}^{j \frac{2 π nk}{N}} & ( 5 )\end{matrix}$$

Developing and reconfiguring the expression (5) to divide it into a real part and an imaginary part results in the expression (6). Here, since x(k)=0 is obtained in a case of N/2≦k≦N−1 based on the expression (4), the expression (6) is expressed into the expression (7).

$$\begin{matrix}[ Math . 6 ] & \\ X ( n ) = {\sum }_{k = 0}^{N - 1} [ {x}_{r} ( k ) cos ( \frac{2 π nk}{N} ) - {x}_{i} ( k ) sin ( \frac{2 π nk}{N} ) ] + j \{ {\sum }_{k = 0}^{N - 1} [ {x}_{r} ( k ) sin ( \frac{2 π nk}{N} ) + {x}_{i} ( k ) cos ( \frac{2 π nk}{N} ) ] \} & ( 6 ) \\ [ Math . 7 ] & \\ X ( n ) = {\sum }_{k = 0}^{N / 2 - 1} [ {x}_{r} ( k ) cos ( \frac{2 π nk}{N} ) - {x}_{i} ( k ) sin ( \frac{2 π nk}{N} ) ] + j \{ {\sum }_{k = 0}^{N / 2 - 1} [ {x}_{r} ( k ) sin ( \frac{2 π nk}{N} ) + {x}_{i} ( k ) cos ( \frac{2 π nk}{N} ) ] \} & ( 7 )\end{matrix}$$

Based on the expression (7), a real part X_{R}(n) of the signal X(n) obtained after the IFFT process is expressed by the expression (8).

$$\begin{matrix}[ Math . 8 ] & \\ {X}_{R} ( n ) = {\sum }_{k = 0}^{N / 2 - 1} [ {x}_{r} ( k ) cos ( \frac{2 π nk}{N} ) - {x}_{i} ( k ) sin ( \frac{2 π nk}{N} ) ] & ( 8 )\end{matrix}$$

The expression (8) is identical to the expression (3), except that the amplitude is half The signal x(k) indicated by the expression (4) is not a signal having the symmetric property, but it can be regarded as a signal substantially having the symmetric property, because x(k)=0 is obtained in a case of N/2≦k≦N−1.

Therefore, in a case where the real-part signal X_{R}(n) expressed by the expression (8) among the signal X(n) obtained as a result of the IFFT process is transmitted as the communication signal, the receiver 20 is able to generate the signal x(k) based on the relationship indicated by the expression (3) by performing the FFT process on the communication signal X_{R}(n). Thus, the receiver 20 is able to restore the transmission data.

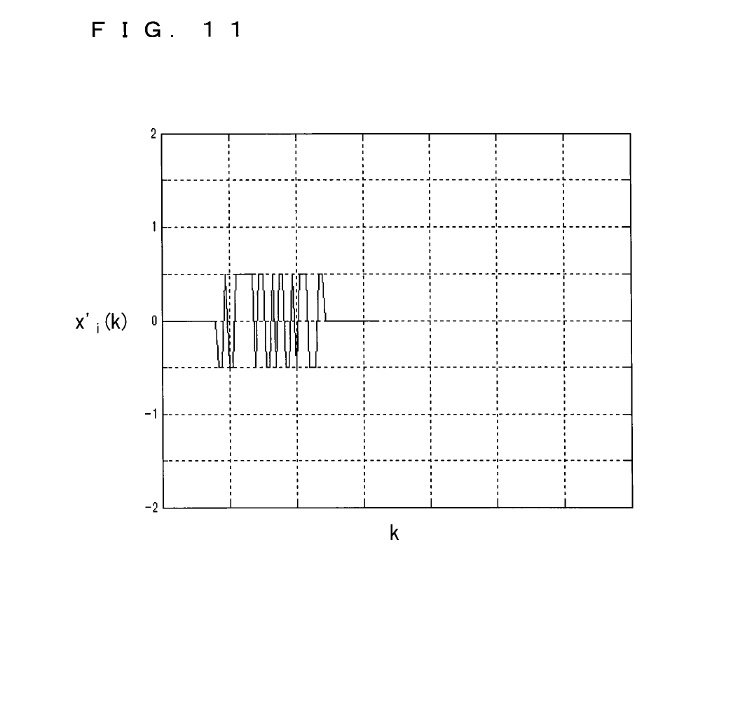

FIGS. 7 to 11 which will be described below show a result of the computer simulation. FIG. 7 shows a real part xᵣ(k) of the input signal x(k) inputted to the IFFT unit 116. FIG. 8 shows an imaginary part xᵢ(k) of the input signal x(k) inputted to the IFFT unit 116. FIG. 9 shows a real-part signal X_{R}(n) obtained as a result of the IFFT process. FIG. 10 shows a real part x′ᵣ(k) of the signal x(k) that is restored by the FFT process being performed on the real-part signal X_{R}(n) obtained as a result of the IFFT process. FIG. 11 shows an imaginary part x′ᵢ(k) of the signal x(k) that is restored by the FFT process being performed on the real-part signal X_{R}(n) obtained as a result of the IFFT process.

Comparing between FIGS. 7 and 10 and comparison between FIG. 8 and FIG. 11, it is found from a result of the computer simulation, too, that the input signal x(k) before the IFFT process can be restored by the FFT process being performed on the real-part signal X_{R}(n) obtained as a result of the IFFT process.

In this manner, in the communication system 1 of this embodiment, the receiver 20 is able to restore transmission data even when data transmission is performed by using subcarriers that are given numbers equal to or less than N/2−1, where the N subcarriers included in the OFDM signal are numbered by integers from 0 to N−1 in ascending order with respect to the frequency of each subcarrier.

As thus far described, in the communication system 1 including the transmitter 10 and the receiver 20, the transmitter 10 includes: the generation means for generating a baseband OFDM signal based on transmission data; and the transmission means for transmitting communication signal that is based on a real-part signal obtained by removing an imaginary-part signal from the baseband OFDM signal. In the baseband OFDM signal, data signal including the transmission data is superimposed on subcarriers that are given numbers equal to or less than N/2−1 while the data signal is not superimposed on subcarriers that are given numbers more than N/2−1, where N (N is an integer) subcarriers included in the baseband OFDM signal are numbered by integers from 0 to N−1 in ascending order with respect to the center frequency of each subcarrier.

The receiver 20 of the communication system 1 includes a reception means for receiving communication signal, and the modulation means for modulating the communication signal to thereby obtain reception data. The modulation means includes a Fourier transform means for converting the communication signal from a signal in the time domain into a signal in the frequency domain. The Fourier transform means receives a signal based on said communication signal as a real-number signal, and receives zero as an imaginary-number signal.

In the transmitter 10 of the communication system 1 described above, the communication signal that is based on the real-part signal obtained by removing the imaginary-part signal is transmitted without any quadrature modulation being performed thereon. Therefore, a configuration for performing the quadrature modulation need not be provided in the transmitter 10. This can downsize the transmitter 10, and achieves cost reduction and power saving.

The receiver 20 receives the real-number signal on which no quadrature modulation has been performed by the transmitter 10. Accordingly, a configuration for quadrature detection and a low pass filter for removing a signal of a high frequency component generated by quadrature detection need not be provided in the receiver 20. This can downsize the receiver 20, and achieves cost reduction and power saving.

The transmitter 10 performs communication without superimposing the data signal on, among all the subcarriers, the subcarriers included in the non-transmission band that are given the numbers more than N/2−1. Accordingly, the band-pass filter for limiting a band of the communication signal can be omitted from the transmitter 10. This can downsize the transmitter 10, and achieves cost reduction.

In the description above, the data signal is assigned to the subcarriers given the numbers equal to or less than N/2−1 while the data signal is not assigned to the subcarriers given the numbers more than N/2−1, in order to cause an input signal inputted to the IFFT unit 116 to be a substantially lateral-symmetrical signal. Here, the assignment of the data signal to the subcarriers may be reversed. That is, it may be acceptable that the data signal is assigned to the subcarriers given the numbers more than N/2−1 while the data signal is not assigned to the subcarriers given the numbers equal to or less than N/2−1, to thereby obtain a substantially lateral-symmetrical signal as an input signal to be inputted to the IFFT unit 116.

<Modification>

Although an embodiment has been described above, the present invention is not limited to the above-described embodiment.

For example, in an example illustrated in the embodiment above, the transmitter 10 and the receiver 20 of the communication system 1 are configured to communicate with each other via wired communication, but it is not limiting. More specifically, the transmitter 10 and the receiver 20 may be configured to communicate with each other via wireless communication. In a case where they are configured to communicate with each other via wireless communication, the transmitter 10 is configured to include a frequency conversion unit for converting a baseband OFDM signal into a carrier-band OFDM signal, but a quadrature modulation unit is not necessary. On the other hand, the receiver 20 is configured to include a frequency conversion unit for converting a carrier-band OFDM signal into a baseband OFDM signal, but a quadrature detection unit is not necessary.

While the invention has been described in detail, the foregoing description is in all aspects illustrative and not restrictive. It is therefore understood that numerous modifications and variations not illustrated herein can be devised without departing from the scope of the invention.

### DESCRIPTION OF THE REFERENCE NUMERALS

1 communication system
10 communication device (transmitter)
20 communication device (receiver)
30 channel
114 primary modulation unit
115 input signal configuration unit
116 IFFT unit
121 transmission unit
201 reception unit
204 FFT unit
LK zone
LS OFDM signal

1. A communication device comprising:
a generation section configured to generate a baseband OFDM signal based on transmission data; and
a transmission section configured to transmit a communication signal that is based on a real-part signal that is obtained by removing an imaginary-part signal from said baseband OFDM signal, wherein
in said baseband OFDM signal, a data signal including said transmission data is superimposed on a subcarrier that is given a number equal to or less than N/2−1, and a data signal is not superimposed on a subcarrier that is given a number more than N/2−1, where N (N is an integer) subcarriers included in said baseband OFDM signal is numbered by integers from 0 to N−1 in ascending order with respect to the center frequency of each subcarrier.

2. The communication device according to claim 1, wherein
said generation section includes:
an assignment section configured to assign said data signal having a primary modulation performed thereon to said subcarrier given the number equal to or less than N/2−1 and assign zero to said subcarrier given the number more than N/2−1, to generate parallel data; and
an inverse Fourier transform section configured to convert said parallel data from data in frequency domain into data in time domain, and output said baseband OFDM signal.

3. A communication device comprising:
a reception section configured to receive a communication signal; and
a modulation section configured to modulate said communication signal and thereby obtain reception data,
said communication signal being a signal based on a real-part signal that is obtained by removing an imaginary-part signal from a baseband OFDM signal,
said modulation section including a Fourier transform section configured to convert said communication signal from a signal in time domain into a signal in frequency domain,
said Fourier transform section being configured to receive a signal that is based on said communication signal as a real-number signal and receive zero as an imaginary-number signal.

4. A communication system comprising:
a first communication device; and
a second communication device configured to communicate with said first communication device,
said first communication device including
a generation section configured to generate a baseband OFDM signal based on transmission data, and
a transmission section configured to transmit a communication signal that is based on a real-part signal that is obtained by removing an imaginary-part signal from said baseband OFDM signal,
said first communication device being configured such that, in said baseband OFDM signal, a data signal including said transmission data is superimposed on a subcarrier that is given a number equal to or less than N/2−1, and a data signal is not superimposed on a subcarrier that is given a number more than N/2−1, where N (N is an integer) subcarriers included in said baseband OFDM signal is numbered by integers from 0 to N−1 in ascending order with respect to the center frequency of each subcarrier,
said second communication device including
a reception section configured to receive said communication signal, and
a modulation section configured to modulate said communication signal and thereby obtain reception data,
said modulation section including a Fourier transform means section configured to convert said communication signal from a signal in time domain into a signal in frequency domain,
said Fourier transform section being configured to receive a signal that is based on said communication signal as a real-number signal and receive zero as an imaginary-number signal.

5. The communication system according to claim 4, wherein
said generation section includes:
an assignment section configured to assign said data signal having a primary modulation performed thereon to said subcarrier given the number equal to or less than N/2−1 and assign zero to said subcarrier given the number more than N/2−1, to generate parallel data; and
an inverse Fourier transform section configured to convert said parallel data from data in frequency domain into data in time domain, and output said baseband OFDM signal.

6. A communication device comprising:
a generation section configured to generate a baseband OFDM signal based on transmission data; and
a transmission section configured to transmit a communication signal that is based on a real-part signal that is obtained by removing an imaginary-part signal from said baseband OFDM signal, wherein
in said baseband OFDM signal, a data signal including said transmission data is superimposed on a subcarrier that is given a number more than N/2−1, and the data signal is not superimposed on a subcarrier that is given a number equal to or less than N/2−1, where N (N is an integer) subcarriers included in said baseband OFDM signal is numbered by integers from 0 to N−1 in ascending order with respect to the center frequency of each subcarrier.

7. A communication system comprising:
a first communication device; and
a second communication device configured to communicate with said first communication device,
said first communication device including
a generation section configured to generate a baseband OFDM signal based on transmission data, and
a transmission section configured to transmit a communication signal that is based on a real-part signal that is obtained by removing an imaginary-part signal from said baseband OFDM signal,
said first communication device being configured such that, in said baseband OFDM signal, a data signal including said transmission data is superimposed on a subcarrier that is given a number more than N/2−1, and the data signal is not superimposed on a subcarrier that is given a number equal to or less than N/2−1, where N (N is an integer) subcarriers included in said baseband OFDM signal is numbered by integers from 0 to N−1 in ascending order with respect to the center frequency of each subcarrier,
said second communication device including
a reception section configured to receive said communication signal, and
a modulation section configured to modulate said communication signal and thereby obtain reception data,
said modulation section including a Fourier transform section configured to convert said communication signal from a signal in time domain into a signal in frequency domain,
said Fourier transform section being configured to receive a signal that is based on said communication signal as a real-number signal and receive zero as an imaginary-number signal.
